(19) United States
(12) Patent Application Publication
(10) Pub. No.: US 2004/0059806 A1
(43) Pub. Date: Mar. 25, 2004

(54) System and method for indicating the status of a communications link/traffic activity on non-protocol aware modules

(76) Inventor: Randall K. Webb, Hillsboro, OR (US)

Correspondence Address: c/o Anne Richards, SCHWEGAN, LUNDBERT, WOESSNER & KLUTH P.A., 1600 TCF Tower, 121 S. Street, Minneapolis, MN, 55402, US

(21) Appl. No.: 10/318,006

(22) Filed: Dec. 13, 2002

Related U.S. Application Data
(63) Continuation-in-part of application No. 10/207,869, filed on Jul. 31, 2002.

(51) Int. Cl. G06F 15/173

(52) U.S. Cl. 709/223

(57) ABSTRACT

A method of controlling at least a light emitting diode (LED) indicator associated with a port included a switch in a data network is provided. Such a method comprises identifying a port in the switch as either a protocol aware port or a non-protocol aware port; and generating a LED message to control operation of the LED indicator associated with the port, when the port is identified as a non-protocol aware port.

### CLAIM FOR PRIORITY

This is a continuation-in-part (CIP) application from an application for “System And Method For Indicating The Status Of A Communications Link And Traffic Activity On Non-Protocol Aware Modules” filed in the United States patent & Trademark Office on Jul. 31, 2002, assigned Ser. No. 10/207,869.

### FIELD

The disclosure relates to data transfer interface technology in a data network and, more particularly, relates to a system and method for indicating a communications link/traffic activity on non-protocol aware modules.

### BACKGROUND

In the case of a complex data network having multiple hosts, such as computer systems and input/output (I/O) controllers connected via switches, a literal sea of cables and port connections may exist. Therefore, connecting and troubleshooting port connections and failures may be difficult. In order to facilitate such troubleshooting, each port in a switch may be provided with a link/activity indicator to indicate the status of a given port. However, where non-protocol aware modules are utilized, the monitoring of traffic over a given port may not be possible and therefore control of the link/activity indicator may be absent. These modules are not protocol aware and do not comprehend management messages within the data network. Non-protocol aware modules are simply repeater modules used to buffer data between the network cables and the switching logic. These repeater modules are typically used in a switch to reduce cost and to maximize data transfer rate. However, without the aid of a functioning link/activity module indicator on a given port, troubleshooting and connecting ports can be extremely difficult.

### BRIEF DESCRIPTION OF THE DRAWINGS

A better understanding of the disclosure will become apparent from the following detailed description of exemplary embodiments and the claims when read in connection with the accompanying drawings, all forming a part of the disclosure of this invention. While the foregoing and following written and illustrated disclosure focuses on disclosing example embodiments of the invention, it should be clearly understood that the same is by way of illustration and example only and the invention is not limited thereto. The spirit and scope of the disclosure are limited only by the terms of the appended claims.

The following represents brief descriptions of the drawings, wherein:

FIG. 1 illustrates an example system that may be used by the example embodiments of the present invention;

FIG. 2 illustrates an example modular configuration diagram used in the example embodiments of the present invention;

FIG. 3 illustrates an example modular configuration diagram used in the example embodiments of the present invention;

FIG. 4 is a flowchart illustrating an example operation performed by the port identification (ID) module used in the example embodiments of the present invention;

FIG. 5 is a flowchart illustrating an example operation performed by the port monitoring module used in the example embodiments of the present invention; and

FIG. 6 is a flowchart illustrating an operation performed by the message scheduler module used in the example embodiments of the present invention.

### DETAILED DESCRIPTION

Before beginning a detailed description of the disclosure, mention of the following is in order. When appropriate, like reference numerals and characters may be used to designate identical, corresponding or similar components in differing figure drawings. Further, in the detailed description to follow, exemplary sizes/models/values/ranges may be given, although the disclosure is not limited to the same. As a final note, well-known components of computer networks may not be shown within the figures for simplicity of illustration and discussion, and so as not to obscure the invention.

Various example embodiments of the disclosure are applicable for use with all types of data networks, I/O hardware adapters and chipsets, including follow-on chip designs which link together end stations such as computers, servers, peripherals, storage subsystems, and communication devices for data communications. Examples of such data networks may include a local area network (LAN), a wide area network (WAN), a campus area network (CAN), a metropolitan area network (MAN), a global area network (GAN), a wireless personal area network (WPAN), and a system area network (SAN), including newly developed computer networks compatible with the “Next Generation Input/Output (NGIO) Specification” as set forth by the NGIO Forum on Jul. 20, 1999, and the “InfiniBand™ Architecture Specification”, Volume 1 and Volume 2, as set forth by the InfiniBand™ Trade Association on Jun. 19, 2001, and those data networks including channel-based, switched fabric architectures which may become available as computer technology advances to provide scalable performance. LAN systems may include Ethernet, FDDI (Fiber Distributed Data Interface) Token Ring LAN, Asynchronous Transfer Mode (ATM) LAN, Fiber Channel, and wireless LAN that are compatible with the “IEEE 802™ standards” as set forth by the Institute of Electrical and Electronics Engineers (IEEE). However, for the sake of simplicity, discussions will concentrate mainly on a host system including one or more hardware adapters for providing physical links for channel connections in a simple data network having several example nodes (e.g., computers, servers and I/O units) interconnected by corresponding links and switches, although the scope of the disclosure is not limited thereto.

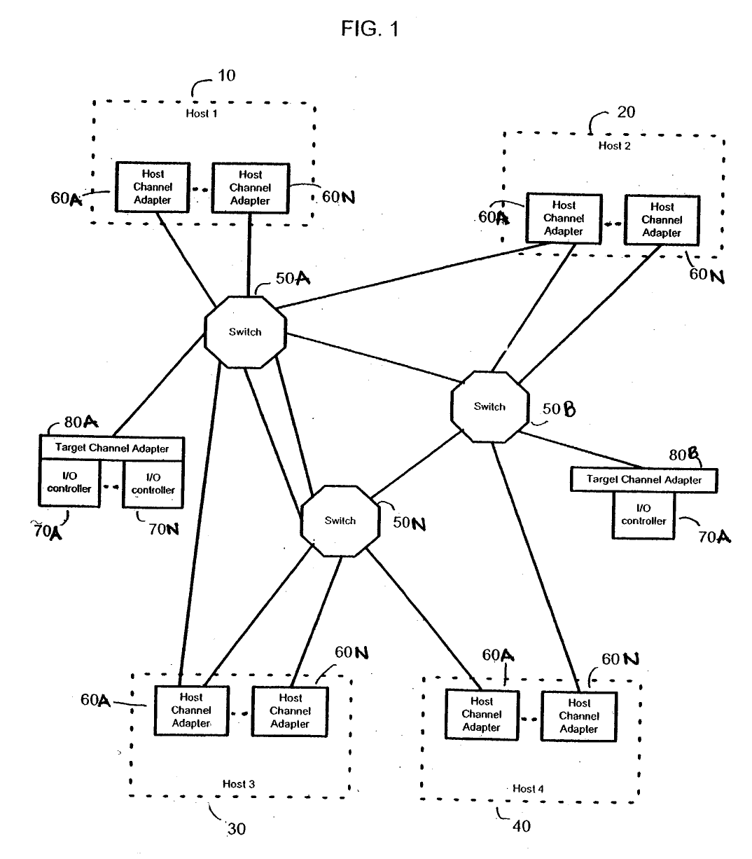

Attention now is directed to the drawings and particularly to FIG. 1, in which an example system that may be used by various embodiments of the disclosure is illustrated. Using an InfiniBand Architecture (IBA) in accordance with the “InfiniBand™ Architecture Specification”, it may be possible to link together a processor-based system 10, through switches 50A-50N to several input/output (I/O) controllers 70A-70N, and other processor-based systems 20, 30 and 40, for example. Each processor-based system 10, 20, 30 and 40 may include one or more central processing units (CPU) (not shown), dynamic random access memory (DRAM) (not shown), memory controller (not shown) and one or more host channel adapters 60A-60N. I/O controllers 70A-70N communicate to the InfiniBand network, via one or more target channel adapters 80A-80B. These I/O controllers 70A-70N may be used to provide an I/O service or I/O function, and may operate to control one or more I/O devices such as storage devices (e.g., hard disk drive and tape drive) via a system area network (SAN), for example. A plurality of switches 50A-50N may be arranged to establish connection between the processor-based systems 10, 20, 30 and 40 and the I/O controllers 70A-70N, via respective host channel adapters 60A-60N and target channel adapters 80A-80B. Each switch 50A-50N as well as the host or target channel adapters 60A-60N and 80A-80N may have one or more switch connection points called “ports” provided to establish connection with every other switch 50A-50N and host channel adapters 60A-60N or target channel adapters 80A-80B, via one or more links. Each switch “port” may be configured to support one or more port operation modes, i.e., one or more links for enabling commands and data to flow between interconnected ports within the InfiniBand™ network. For example, each switch “port” can be configured to serve as a single link (1×) capable port for transferring data via a single link (typically 0.25 GB/s in each direction, for example), or a multiple link capable port for transferring data via respective multiple links (typically 1.0 GB/s in each direction, for example).

Referring to FIG. 1, the InfiniBand Architecture (IBA) defines interfaces that move data between two memory regions or nodes. Access to the I/O controllers 70A-70N and the processor-based systems 10, 20, 30 and 40, may be accomplished by send or receive operations, as well as, remote direct memory access (RDMA) read and RDMA write operations, in accordance with the “InfiniBand™ Architecture Specification”, Volume 1, Chapter 9.4. Each of the host processor-based systems 10, 20, 30, and 40 and the I/O controllers 70A-70N may serve as an individual service provider or an individual InfiniBand™ client requesting services from the service provider in a client/server model, for example. One or more host channel adapters 60A-60N may be installed in each host processor-based system 10, 20, 30, and 40. Likewise, one or more target channel adapters 80A-80B may be installed in each of the I/O controllers 70A-70N. Communications in an InfiniBand architecture (IBA) may be accomplished through the cluster, host channel adapters 60A-60N, target channel adapters 80A-80B directly or through one or more switches 50A-50N.

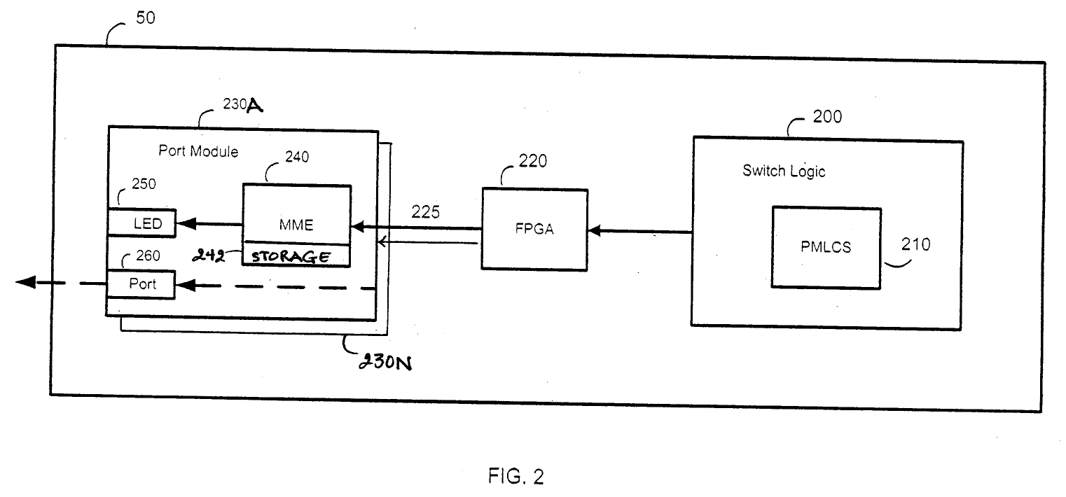

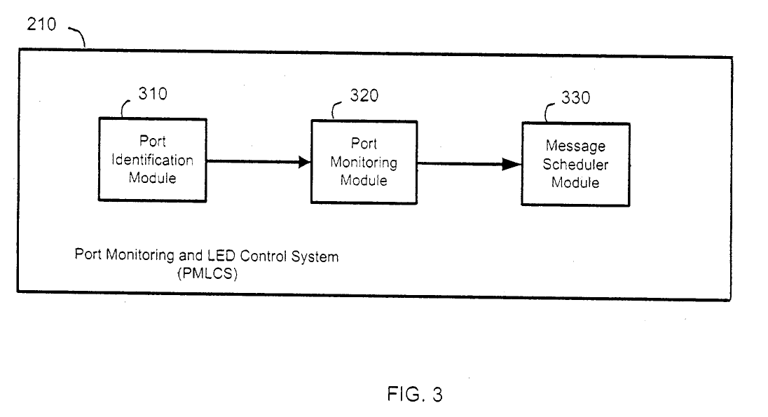

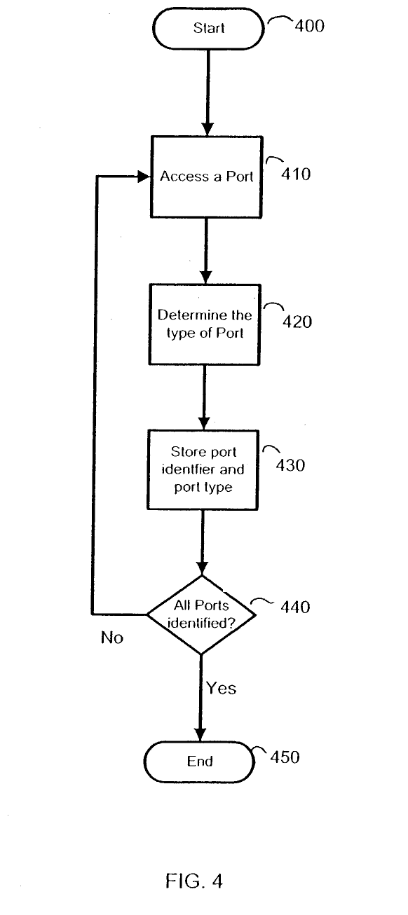

Before proceeding into a detailed discussion of the logic used by the disclosure it should be mentioned that the modular configuration diagrams shown in FIGS. 2 and 3 and the flowcharts shown in FIGS. 4 through 6 contain software, firmware, hardware, processes or operations that correspond, for example, to code, sections of code, instructions, commands, objects, or the like, of a computer program that is embodied, for example, on a storage medium such as floppy disk, CD-ROM (Compact Disc Read-Only Memory), EP-ROM (Erasable Programmable Read-Only Memory), RAM (Random Access Memory), hard disk, etc. Further, the computer program can be written in any programming language such as, but not limited to, for example C++ and Visual Basic.

FIG. 2 illustrates an example modular configuration diagram used in the example embodiments of the disclosure. This modular configuration diagram depicts the hardware, firmware, and software that may be utilized to control one or more port module indicators such as light emitting diodes (“LED”) indicators on a non-protocol aware port in a switch. In addition, since management links (MLs) reside in a switch according to an embodiment of the disclosure, port module indicators such as LED indicators may only be monitored using the disclosure in a switch, not in channel adapters. However, the monitoring of port activity may reside outside the switch, with appropriate commands sent to the switch resulting in ML messages (commands) to the port module indicators such as LED indicators within the switch. Each switch may contain multiple inbound and outbound ports for relaying data between links in the InfiniBand™ network in compliance with the “InfiniBand™ Architecture Specification”.

As shown in FIG. 2, the switch 50 may comprise a switch logic 200 including a port monitoring and LED control system (PMLCS) 210 arranged to provide link/activity information to all available ports in the switch 50; and a field-programmable gate array (FPGA) 220 arranged to control operation of one or more port modules 230A-230N each supporting a corresponding port 260. The field-programmable gate array (FPGA) 220 may be arranged to determine if an individual port module 230A-230N in the switch 50 is a non-protocol aware module so as to separate all non-protocol aware ports from all protocol aware ports, to interpret the link/activity information, to create an appropriate ML message and provide the appropriate ML message to each of the port modules 230A-230N that is determined as a non-protocol aware module, i.e., a port module that is not protocol aware and does not comprehend management messages within the data network (i.e., is incapable of utilizing management messages within the data network), such as a repeater module used to buffer data between the network cables and switching logic. In contrast to non-protocol aware modules, protocol aware modules are modules that can process management messages (commands) as defined, for example, in the “InfiniBand™ Architecture Specification”, Volume 1.

Each of the port modules 230A-230N may contain a module management entity (MME) 240 arranged to perform the requested operation, and format a response accordingly; a link/activity module indicator 250, such as one or more functionally independent single-colored light emitting diodes (“LEDs”) arranged to provide visual indications to the user to show the activity status of the corresponding port module under control of the module management entity (MME) 240; and a port 260 provided to establish connection with every other switch, host or target channel adapters in the data network, via one or more links. The module management entity (MME) 240 may be connected to the field programmable gate array (FPGA) 220, via a respective ML 255, and may contain a non-volatile storage 242 to hold module information, typically in MME function registers (not shown) that are predefined by a manufacturer to identify if the corresponding port module is a protocol aware module or a non-protocol aware module.

Alternatively, the FPGA 220 may be included in the switch logic 200, or elsewhere within the switch 50. Likewise, the PMLCS 210 may be arranged within the FPGA 220, or elsewhere within the switch 50. In such configurations, the switch logic 200 or the FPGA 220 may interface with all port modules 230A-230N, and interpret the link/activity information to create the appropriate ML message that may be sent to the appropriate port module 230 and the module indicator (LEDs) 250 via a respective ML 225. According to the “InfiniBand™ Architecture Specification”, Volume 2, the management link (ML) may be a multi-master, two-wire serial bus used in a managed switched chassis for a number of management functions, such as to allow for access to define facilities on the port module, including link/activity indicator LEDs, and to allow for certain defined operations to be sourced from the port module to the managed switch chassis. Therefore, ML messages created by the PMLCS 210 or the FPGA 220 may indicate request transactions that are compatible with ML signaling and protocols established by the InfiniBand™ specification. For example, if a single-colored LED is used as a module indicator 250, ML-LED messages may be created to request for visual indications of the module status. ML-LED messages may be encoded in management datagram (MAD) packets that are transmitted and received in accordance with “InfiniBand™ Architecture Specification”, Volume 1, Chapter “General Services”, Chapter “Data Packet Format” and Chapter “Management Model”, Section “Management Datagrams”. These ML-LED messages may be available in three forms. First, one ML-LED message may indicate that no link is established, and no data is being transmitted by the port 260 and, as such, the LED indicator 250 included in the port module 230 in question may be deactivated (i.e., turned “OFF”). Second, another ML-LED message may indicate that the port 260 is linked to another device and, as such, the LED indicator 250 may be activated (i.e., turned “ON”). Third, another ML-LED message may indicate that data is being transmitted over the port 260 and, as such, the LED indicator 250 may be instructed to “blink” at a predetermined rate. Alternatively, if two functionally independent single-colored LEDs are used as module indicators 250, ML-LED messages may be created to request visual indications of the module status described as well as the attention event of the corresponding port module.

FIG. 3 illustrates an example modular configuration diagram depicting the PMLCS 210 used in the example embodiments of the disclosure. As shown in FIG. 3, the PMLCS 210 may include a port identification module 310, a port monitor module 320, and a message scheduler module 330. The port identification module 310 may be used to access all port modules 230A-230N, via respective management links (MLs) 225, and determine if an individual port module is a protocol aware module or a non-protocol aware module based on the module information predefined by a manufacturer stored in the non-volatile storage 242 of the respective MME 240.

During communications with the port identification module 310, the port monitoring module 320 may be used to receive the link/activity information regarding a particular port 260 and determine the appropriate action to take depending upon the nature of such a port 260. If the switch port in question is a non-protocol aware port, i.e., the switch port attached to a non-protocol aware port module, then the link/activity information may be transmitted to a message scheduler module 330 to create a ML-LED message for each non-protocol aware port (i.e., a switch port attached to a non-protocol aware port module) and schedule the transmission of ML-LED messages to all switch ports attached to non-protocol aware modules in a particular order or priority with reference to other management messages, such as, for example, when the ML 225 is not busy. Thereafter, the ML-LED messages may be transmitted to the MME 240 of the non-protocol aware port modules, via the ML 255.

FIG. 4 is a flowchart illustrating an example operation performed by the port identification module 310 used in the example embodiments of the disclosure. According to an embodiment of the disclosure, the port identification module 310 may access the MME 240 of each port module 230A-230N at the same time or in a sequence until all switch ports 260 attached to all port modules 230A-230N are identified as either protocol aware ports or non-protocol aware ports. For example, the port identification module 310 may begin execution at block 400, typically when the switch 50 is activated (“power-on”), and proceed to access the MME 240 of each port module 230A-230N, via a respective ML 255 at block 410, as shown in FIG. 4. Upon accessing the MME 240 of a port module 230A-230N, the port identification module 310 determines the type of the switch port 260 attached to the port module 230A-230N at block 420, that is, if the port module 230A-230N is either a protocol aware module or a non-protocol aware module based on the module information stored in the non-volatile storage 242 of the MME 240.

When the type of the switch port 260 attached to the port module 230A-230N is determined, the port identification module 310 stores the port type and its port identifier (ID) in an internal storage at block 430. One example implementation of such an internal storage may be a look-up table used to contain port identifiers (IDs) and port types of all switch ports attached to all available port modules 230A-230N. For example, port #1 attached to port module 230A may be designated as a protocol aware port. Port #2 attached to port module 230B may be designated as a non-protocol aware port. Likewise, port #N attached to port module 230N may be designated as a non-protocol aware port. Thereafter, the port identification module 310 determines if all switch ports attached to all available port modules 230A-230N within a switch 50 have been identified at block 440. If all switch ports attached to all available port modules 230A-230N within a switch 50 have not been identified, then the port identification module 310 returns to block 410 to complete all port determinations. Otherwise, the port identification module 310 terminates processing at block 450.

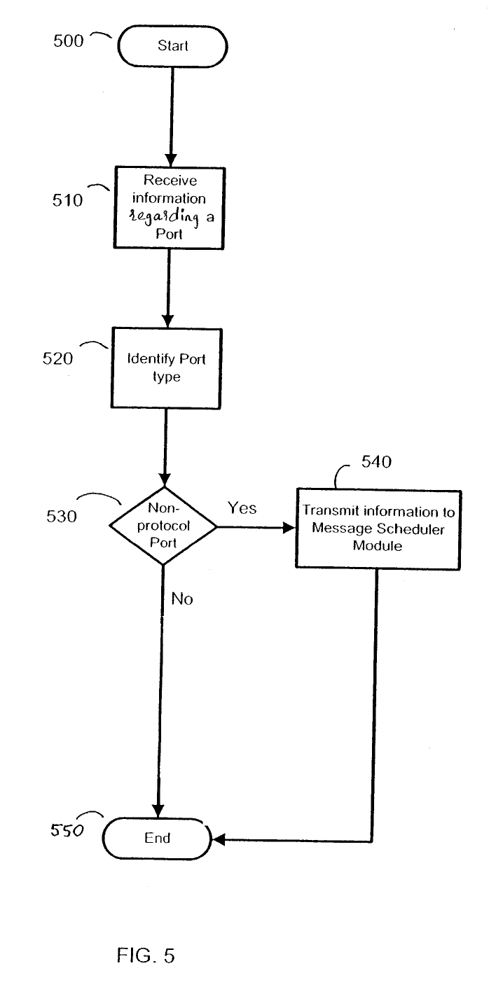

FIG. 5 is a flowchart illustrating an example operation performed by the port monitoring module 320 used in the example embodiments of the disclosure. The port monitoring module 320 begins execution at block 500, typically when the link/activity information is generated from the switch logic 200, and proceeds to receive the link/activity information regarding a port 260 attached to a port module 230A-230N from the switch logic 200 to be transmitted to a particular port module's MME 240 at block 510. Thereafter, the port monitoring module 320 retrieves the port identifier (ID) and the port type for the particular port module 230 stored in the internal storage of the port identification module 310 at block 520. Next, the port monitoring module 320 determines if the port 260 is a non-protocol aware port, i.e., a port attached to a non-protocol aware port module, at block 530. If the port 260 is a non-protocol aware port, then the port monitoring module 320 transmits the link/activity information to the message scheduler module 330 for schedule transmission to the port module's MME 240 at block 540 and then terminates at block 550. However, if the port 260 is not a non-protocol aware port, i.e., the port is a protocol aware port, the port monitoring module 320 may terminate at block 550 and need not transmit any link/activity information to the message scheduler module 330. This is because the MME 240 of the protocol aware modules typically generates its own link/activity information to drive its LED. As a result, no ML-LED messages need to be created and transferred, via a respective ML 255.

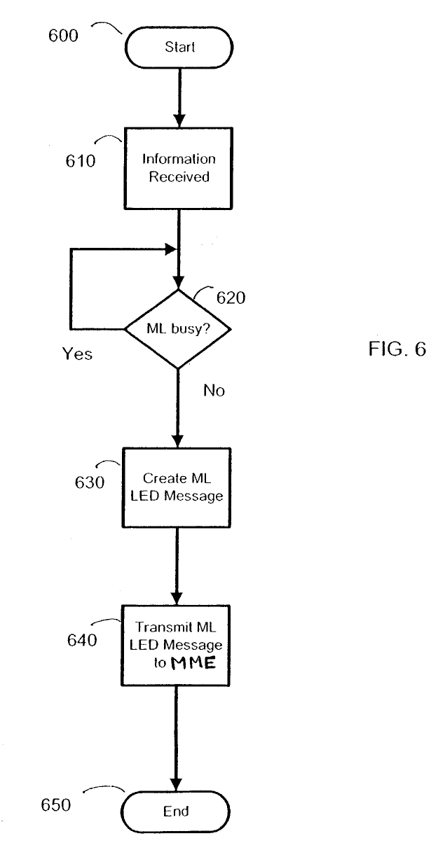

FIG. 6 is a flowchart illustrating an example operation performed by the message scheduler module 330 used in the example embodiments of the disclosure. The message scheduler module 330 begins execution at block 600, and proceeds to receive the link/activity information from the port monitoring module 320 to be transmitted to the MME 240 included in the port module 230 in question at block 610. Upon receipt of the link/activity information regarding a port 260 attached to the port module 230 in question, the message scheduler module 330 determines if the corresponding ML 225 is busy at the given moment at block 620. If the ML 225 is busy, perhaps transmitting management messages of higher priority, then the message scheduler module 330 may wait until the ML 225 is no longer. However, if the ML 225 is not busy, then the message scheduler module 330 proceeds to create an appropriate ML-LED message at block 630. As previously described, the ML-LED message may take one of three forms. First, the ML-LED message may indicate that no link is established, and no data is being transmitted by the port 260 and, as such, the LED indicator 250 included in the port module 230 in question may be deactivated (i.e., turned “OFF”). Second, the ML-LED message may indicate that the port 260 is linked to another device and, as such, the LED indicator 250 may be activated (i.e., turned “ON”). Third, the ML-LED message may indicate that data is being transmitted over the port 260 and, as such, the LED indicator 250 may be instructed to blink at a predetermined rate. Regardless of the status, the ML-LED message may then be transmitted to the MME 240 included in the port module 230 at block 640. Thereafter, the message scheduler module 330 terminates at block 650.

As described in the foregoing, the benefit resulting from the disclosure is that control of an LED indicator associated with the port in one or more non-protocol aware (NPA) modules within a switch may be accomplished without interrupting operations of the switch or interfering the operations of protocol aware ports, while utilizing the existing switch infrastructure (i.e., the management link “ML” to each module and the module's MME). Utilizing the disclosure the costs associated with properly driving the link and activity LED indicator on a non-protocol aware module (e.g., circuitry, module board space, power consumption, etc.) can be dramatically reduced. Likewise, the amount of time and effort required to install cables in a server network and debug problems in a server network can be drastically reduced.

While we have shown and described only a few examples herein, it is understood that numerous changes and modifications as known to those skilled in the art could be made to the example embodiment of the disclosure. For example, the data network as shown in FIG. 1 may be configured differently or employ fewer or different components than those illustrated. Such a data network may include a local area network (LAN), a wide area network (WAN), a campus area network (CAN), a metropolitan area network (MAN), a global area network (GAN) and a system area network (SAN), including newly developed computer networks which may become available as computer technology advances in the future. However, the port configuration for LED indicators shown in FIGS. 2-3 on a switch may need to be adjusted accordingly. In addition, the port configuration for LED indicators can be implemented either in hardware or software module (i.e., an application program) installed in the host node (end node or switch) in the InfiniBand network. Therefore, we do not wish to be limited to the details shown and described herein, but intend to cover all such changes and modifications as are encompassed by the scope of the appended claims.

1. A method of controlling an indicator associated with a port of a device, the indicator being capable of indicating at least one of active port links and link activities, the method comprising:
identifying a port on a device as either a protocol aware port or a non-protocol aware port; and
generating an indicator message to control operation of the indicator associated with the port, when the port on the device is identified as a non-protocol aware port.

2. The method as claimed in claim 1, further comprising:
receiving link/activity information regarding the port; and
scheduling transmission of the indicator message to the indicator associated with the port, via a management link, when the port on the device is identified as a non-protocol aware port.

3. The method as claimed in claim 2, wherein the indicator message indicates an instruction perform one of the followings: to activate the indicator when the associated non-protocol aware port is linked to another port, to deactivate the indicator when the associated non-protocol aware port is not linked to another port, and to enable the indicator to blink at a predetermined rate, when the associated non-protocol aware port is transmitting and/or receiving information to/from another port.

4. The method as claimed in claim 3, wherein the scheduling transmission of an indicator message to an indicator associated with the non-protocol aware port via a management link, further comprises:
determining if a management link connected to the non-protocol aware port is busy; and
transmitting the indicator message to a management entity to control operation of the indicator, when the management link is not busy.

5. The method as claimed in claim 4, wherein the non-protocol aware port is a repeater port that is incapable of utilizing management messages within a data network, and the protocol aware port is a port that is capable of utilizing management messages within a data network.

6. An article comprising:
a storage medium to store instructions that, when executed by a machine, result in the following:
identifying ports on a device as either protocol aware or non-protocol aware ports;
receiving information to be transmitted over a non-protocol aware port;
scheduling transmission of an indicator message to a light emitting diode (LED) indicator associated with the non-protocol aware port over a management link; and
transmitting the indicator message to control operation of the LED indicator.

7. The article as claimed in claim 6, wherein the indicator message indicates an instruction to perform one of the followings: to activate the LED indicator when the associated non-protocol aware port is linked to another port; to deactivate the LED indicator when the associated non-protocol aware port is not linked to another port, and to enable the LED indicator to blink at a predetermined rate, when the associated non-protocol aware port is transmitting and/or receiving information to/from another port.

8. The article as claimed in claim 6, wherein the scheduling transmission of an indicator message to a link/activity indicator associated with the non-protocol aware port via a management link, further comprises:
determining if a management link connected to the non-protocol aware port is busy; and
transmitting the indicator message to a management entity to control operation of the link/activity indicator, when the management link is not busy.

9. The article as claimed in claim 6, wherein the non-protocol aware port is a repeater port that is incapable of utilizing management messages within a data network, and the protocol aware port is a port that is capable of utilizing management messages within the data network compatible with the “InfiniBand™ Architecture Specification”.

10. A switch for relaying data between links in a data network, comprising:
a plurality of port modules each including at least a light emitting diode (LED) indicator and a port provided to establish connection with another device, via one or more links; and
a switch logic connected to the port modules, via respective management links (MLs) to control operation of the switch, including to determine if the port included in the corresponding port module is a protocol aware port or a non-protocol aware port, and to control the LED indicator included in the corresponding port module when the port is a non-protocol aware port.

11. The switch as claimed in claim 10, wherein the switch logic comprises:
a port identifier to access and identify all ports included in respective port modules as either protocol aware ports or non-protocol aware ports;
a port monitor to receive link/activity information provided by the switch regarding to the link status of either a protocol aware port or a non-protocol aware port; and
a message scheduler to create and transmit LED messages to a module management entity (MME) included in the corresponding port module to control operation of the LED indicator associated with a non-protocol aware port, when the port has been identified as a non-protocol aware port.

12. The switch as claimed in claim 10, wherein the non-protocol aware port is a repeater port that does not comprehend management messages within a data network, and the protocol aware port is a port that comprehends management messages within the data network compatible with the “InfiniBand™=0 Architecture Specification”.

13. The switch as claimed in claim 10, wherein the message scheduler is activated by the port monitor to transmit a first LED message to turn on the LED indicator when the associated non-protocol aware port is linked to another device, via one or more links; a second LED message turn off the LED indicator when the associated non-protocol aware port is not linked to another device, via one or more links; and a third LED message to enable the LED indicator to blink at a predetermined rate when the associated non-protocol aware port is transmitting and/or receiving data to/from another device.

14. The switch as claimed in claim 11, wherein the module management entity (MME) included in the corresponding port module contains a non-volatile storage for holding module information predefined by a manufacturer to identify if the port included in the corresponding port module is a protocol aware port or a non-protocol aware port, and the switch logic accesses the MME to determine if the port included in the corresponding port module is a protocol aware port or a non-protocol aware port.

15. The switch as claimed in claim 10, wherein the switch logic comprises a field programmable gate array (FPGA) arranged to send all appropriate LED messages to the corresponding non-protocol aware port.

16. A device of controlling an indicator associated with a port of a device, the indicator being capable of indicating at least one of active port links and link activities, the device comprising:
a first circuit adapted to identify a port on a device as either a protocol aware port or a non-protocol aware port; and
a second circuit adapted to generate an indicator message to control operation of the indicator associated with the port, when the port on the device is identified as a non-protocol aware port.

17. The device as claimed in claim 16, wherein the second circuit is further adapted to schedule transmission of the indicator message to the indicator associated with the port, via a management link, when the port on the device is identified as a non-protocol aware port.

18. The device as claimed in claim 16, wherein the indicator message indicates an instruction perform one of the followings: to activate the indicator when the associated non-protocol aware port is linked to another port, to deactivate the indicator when the associated non-protocol aware port is not linked to another port, and to enable the indicator to blink at a predetermined rate, when the associated non-protocol aware port is transmitting and/or receiving information to/from another port.

19. The device as claimed in claim 17, wherein the second circuit is further adapted to determine if a management link connected to the non-protocol aware port is busy, and transmit the indicator message to a management entity to control operation of the indicator, when the management link is not busy.

20. The device as claimed in claim 19, wherein the non-protocol aware port is a repeater port that is incapable of utilizing management messages within a data network, and the protocol aware port is a port that is capable of utilizing management messages within a data network.
